(19) United States
(12) Patent Application Publication
(10) Pub. No.: US 2003/0121332 A1
(43) Pub. Date: Jul. 3, 2003

(54) Pressure transducer with dual slope output

(76) Inventors: Santhi E. Mathew, Londonderry, NH (US); Kerry S. Lahey, Litchfield, NH (US); Leonid Mindlin, South Natick, MA (US); Jim M. Poulin, Derry, NH (US); Claudia J. Quigley, Lexington, MA (US); Gardy F. St.Paul, Everett, MA (US); Irving Weiner, Sharon, MA (US)

Correspondence Address: HALE AND DORR, LLP, 60 STATE STREET, BOSTON, MA, 02109

(21) Appl. No.: 10/027,412

(22) Filed: Dec. 21, 2001

(51) Int. Cl. G01L 9/00

(52) U.S. Cl. 73/753

(57) ABSTRACT

A pressure transducer has an output characterized by two or more slopes. A pressure transducer generates an first output signal that may be linearly proportional to the sensed pressure. The pressure transducer includes an electrical circuit that shapes the first output signal to produce a shaped output signal that according to a first function of the first output signal when the first output signal is less than the first value and according to a second function of the first output signal when the first output signal is greater than a second value. Preferably, the shaped output signal is a dual slope signal such that the shaped output signal has a first linear portion characterized by a first slope and a second linear portion characterized by a second slope. The two linear portions of the shaped output signal may intersect at a knee point which corresponds to a pressure between two preferred desired pressure ranges. Preferably, the knee point corresponds to a sensed pressure that is approximately 10 percent of the maximum pressure sensed by the device. The higher slope may correspond to lower measured pressures and the lower slope may correspond to higher measured pressures. Preferably, the higher slope is high enough that even in low output voltage ranges, the shaped output signal can be resolved by an analog-to-digital converter to a desired degree of precision. Preferably, the total range of the output voltage is the same as the total range of the first output voltage.

### FIELD OF THE INVENTION

The invention relates generally to pressure transducers and more specifically to electrical circuits for use with pressure transducers.

### BACKGROUND OF THE INVENTION

Pressure transducers are one type of device used as manometers in a variety of systems to take measurements related to fluid pressure, particularly in connection with maintaining a particular fluid pressure or pressure range. A pressure transducer converts a sensed pressure into a calibrated value of a particular form. Typically, a pressure transducer converts a sensed pressure into a calibrated electrical value that can be transmitted to and used in electrical circuits or systems, e.g., electronic circuitry that controls the pressure of a fluid in a system.

Capacitive pressure transducers are one popular type of pressure transducer. Capacitive pressure transducers use a capacitive sensor to sense physically the pressure of the fluid whose pressure is being measured and produce an electrical output signal representative of the sensed pressure.

Generally, a capacitive pressure transducer employs a variable capacitor to sense the pressure of a fluid (liquid or gas) or to sense a pressure differential between two fluids. The two plates of the variable capacitor are formed by electrodes that include conductors disposed to provide conductive surfaces positioned parallel to each other. The electrodes are designed so that the first plate of the capacitor is fixed, and the second plate (or a portion thereof) of the capacitor moves relative to, i.e., toward or away from, the fixed plate when the pressure of a fluid being measured is applied to the pressure transducer. As the distance between the plates changes, the capacitance of the variable capacitor changes in accordance with the well-known equation, C=Ae/d, in which C is the capacitance between the two parallel plates, A is the common area between the plates, e is the dielectric constant of the material between the plates (e=1 for a vacuum) and d is the distance between the plates. The change in the capacitance between the two plates may be electrically sensed to measure the desired pressure.

Designs of some capacitive transducers are described in U.S. Pat. No. 5,911,162, entitled “Capacitive Pressure Transducer With Improved Electrode Support,” having a common assignee with the present invention. FIG. 1 illustrates a representative capacitive pressure transducer 100 with which the present invention may be practiced. Generally, in a known design for such a transducer 100 shown in FIG. 1, a housing 160 defines two interior chambers, a first chamber 110 for receiving a fluid whose pressure is to be sensed, and a second chamber 112 for providing a reference or relative pressure and for sensing the desired pressure. The two electrodes 120, 130 are mounted in the housing 160, generally with their conductive surfaces parallel to each other and spaced apart by a small gap to form a parallel plate capacitor 138. The first electrode 130 is fixed relative to the housing 160. In one design, the fixed first electrode 130 includes a ceramic support disk with a conductive plate formed on a surface by thin film deposition techniques. The movable second electrode, or diaphragm, 120 is in fluid communication with the fluid whose pressure is being sensed, typically by forming one wall of the interior chamber 110, and movable relative to the housing 160 and to the first electrode 130 in response to the received fluid. The movable second electrode is a flexible diaphragm 120, typically made of metal. The movable second electrode 120 is typically fixed to the housing 160 at its periphery, for example, by having its periphery clamped between two portions of the housing 160, and extends across the housing 160 to define first and second chambers 110, 112 within the interior of the housing 160. The second chamber 112 has a reference inlet 174 by which a known reference pressure can be established, e.g., zero pressure. The first chamber 110 has an inlet 144 for receiving the fluid to be sensed. The presence of the fluid causes a central portion of the diaphragm 120 to flex in response to changes in the pressure of the fluid. This flexing movement causes the gap between the electrodes 120, 130, and, consequently, the capacitance provided by them, to change. The change in capacitance provided by the first and second electrodes 120, 130 can be electrically sensed and related to the pressure of the received fluid.

Since diaphragm 120 is welded to the housing 160, the housing 160 provides electrical connection to the diaphragm 120. The change in capacitance is typically measured by providing an electrical signal to the first electrode 130. Transducer 100 includes an electrically conductive feedthrough 180, insulated from a housing cover 170 by insulating plug 185, to permit measurement of the capacitance provided by capacitor 138. One end 182 of feedthrough 180 is in contact with a portion of electrode 130. The other end 184 of feedthrough 180 is external to housing 160. Known electrical circuits may be used to measure the capacitance provided by capacitor 138 and to provide an electrical signal representative of the differential pressure. So the capacitance provided by capacitor 138 may be measured by electrically connecting a measuring circuit, e.g., forming a portion of front end electronics 188, between housing 160, with lead 187, and the outer end 184 of feedthrough 180, with lead 186. In practice, the body 160 of transducer 100 and hence diaphragm 120, is normally grounded, so the capacitance may be measured simply by electrically connecting the measuring circuit to the outer end 184 of feedthrough 180. The front end electronics 188 that are connected to the capacitive transducer 100 may include additional circuits, for example, to scale the signal to the desired output range. The intermediate output signal representative of the sensed pressure produced by the measuring circuit and/or other circuitry in the front end electronics 188 at its output 189 may have the characteristic shown in FIG. 2.

Pressure transducers are generally designed to operate over predefined pressure ranges. If a pressure transducer is exposed to a fluid pressure outside its operating range, typically the output of the transducer will no longer accurately represent the actual fluid pressure, the transducer may become damaged, or both. The operating range of a capacitive pressure transducer may be determined by, for example, a combination of the physical structure of the capacitive transducer portion, the material composition of the transducer's components, the operating temperatures, and other factors.

As discussed above, the input pressure range is one important parameter that defines the operational characteristics of a particular pressure transducer. Another such parameter is the transducer's output range. That is, pressure transducers are generally designed so that their electrical output signals fall within a predefined operating range. The output range will typically be selected to satisfy the requirements of the system within which the pressure transducer may be used. An industry standard may dictate a required or preferred output range to ensure compatibility with other systems. In voltage-mode pressure transducers, the voltage of the output signal is the relevant characteristic of the output signal that is calibrated to, and indicative of, the sensed pressure. A typical output range for a pressure transducer may be zero volts to ten volts. An output of zero volts may correspond to a sensed pressure equal to the minimum, or 0%, of the pressure range, and an output of ten volts may correspond to a sensed pressure equal to the maximum, or 100%, of the pressure range. The outputs of prior art pressure transducers are typically linear functions of the sensed pressure; intermediate output voltages proportionally correspond to the sensed pressure. For example, an output of one volt may correspond to a sensed pressure of 10% of the maximum pressure, and an output of nine volts may correspond to a sensed pressure of 90% of the maximum pressure. Pressure transducers often incorporate “conditioning electronics” that compensate for non-linearities in the transducer and ensure that a linear relationship between input pressure and output signal is maintained over the output range. A graph of a typical output function for a prior art pressure transducer is shown in FIG. 2. For many applications, it is desired that the analog output of a pressure transducer be available in digital form; accordingly, the output of a pressure transducer may typically be fed as an input to an analog-to-digital converter that will resolve the analog output values into digital representations.

The desired operating pressure range will vary with the application in which the pressure transducer is used. An exemplary application for a pressure transducer is in semiconductor manufacturing. A semiconductor manufacturing system may require a total pressure range of, e.g., 0 to 200 milliTorr. That is, the semiconductor manufacturing system may require that a pressure within a particular chamber be measured and controlled within the range of zero to 200 milliTorr. For a transducer that measures the pressure of the chamber in this example, in FIG. 2, 100% of the maximum pressure would correspond to a measured pressure of 200 milliTorr and would produce an output of ten volts.

Within the total operating pressure range for a particular system, two pressure subranges may be of interest. For example, in some semiconductor fabrication facilities, the fluid pressure within a particular chamber must be maintained between 5-8 milliTorr when semiconductors are actually being manufactured, while the fluid pressure within that same chamber must be maintained between 180-200 milliTorr when the system is being purged. One way to design such a system is to couple two pressure transducers to the chamber: one with an input pressure range from zero to about ten milliTorr, for accurately monitoring the chamber pressure during manufacturing; and another with a higher input pressure range selected for accurately monitoring chamber pressure during the higher pressure purge cycles. While using two such pressure transducers advantageously provides a high degree of accuracy, it also disadvantageously increases the cost of the system.

Another approach to designing such a system is to use a single pressure transducer to monitor the pressure within the chamber. A pressure transducer with an input pressure range of zero to 200 milliTorr could be used to monitor the pressure of such a chamber during both the manufacturing cycles (i.e., low range of 5-8 milliTorr) and during the purge cycles (i.e., high range of 180-200 milliTorr). Although use of such a single transducer advantageously decreases the system cost, it also disadvantageously reduces the accuracy of the pressure measurement of interest. The pressure range of the highest interest is typically the range in which manufacturing is actually taking place (5-8 milliTorr in this example). If a pressure transducer with an input pressure range of zero to 200 milliTorr, and a linear output range from zero to ten volts, is used, then the transducer output signal corresponding to 5 milliTorr will equal 0.25 volts and the output signal corresponding to 8 milliTorr will equal 0.4 volts. So, the output range corresponding to the most important input pressure range will span only a tiny fraction (i.e., from 0.25 to 0.4 volts) of the transducer's total output range (i.e., from zero to ten volts). Although such a system can function in principle, in practice it tends to be inaccurate. For example, the output signal of the pressure transducer is typically applied to an analog-to-digital converter to enable monitoring of the pressure by digital equipment such as a microprocessor. However, many systems use analog-to-digital converters with relatively poor resolution. Poor resolution in the converted digital signal may pose a particular problem for a desired pressure subrange that corresponds to a low pressure transducer output voltage, e.g., below 1 volt. For example, two analog values that are fairly close together may get converted to the same digital representation. Subtle variations in the pressure may not be indicated accurately. Consequently, there is a need for a pressure transducer output that has improved signal characteristics. There is also a need for a system for inexpensively monitoring pressure at multiple sub-ranges of interest.

### SUMMARY OF THE INVENTION

The present invention is directed to providing a pressure transducer output characterized by two or more slopes. A pressure transducer in accordance with preferred embodiments of the present intervention generates an intermediate output signal and includes an electrical circuit that shapes the intermediate output signal to produce a shaped output signal that has two or more slopes. The intermediate output signal may be linear or non-linear.

In some embodiments, the shaped output signal is a dual slope signal such that the shaped output signal has a first linear portion characterized by a first slope and a second linear portion characterized by a second slope. The two linear portions of the shaped output signal intersect at a knee point which may correspond to a pressure between two desired input pressure ranges. In some embodiments, the knee point corresponds to a sensed pressure that is approximately ten percent of the maximum pressure sensed by the device. It is contemplated that in some embodiments the higher slope of the two slopes corresponds to lower sensed pressures and the lower slope corresponds to higher sensed pressures. The higher slope may be high enough that even in low output voltage ranges, the shaped output signal can be resolved by an analog-to-digital converter to a desired degree of precision. The total range of the output voltage may be the same as the total range of the intermediate output voltage.

The electrical circuit that shapes the intermediate output signal may boost the slope of the intermediate output signal below the knee point and attenuate the slope of the intermediate output signal above the knee point to produce the output signal. In some embodiments, one portion of the electrical circuit defines the knee point, one portion boosts the slope of intermediate output signal and one portion attenuates the slope of the intermediate output signal. The electrical circuit may include one or more operational amplifier stages that produce the shaped output signal.

These and other features and advantages of the present invention will become readily apparent from the following detailed description, wherein embodiments of the invention are shown and described by way of illustration of the best mode of the invention. As will be realized, the invention is capable of other and different embodiments and its several details may be capable of modifications in various respects, all without departing from the invention. Accordingly, the drawings and description are to be regarded as illustrative in nature and not in a restrictive or limiting sense, with the scope of the invention being indicated in the claims.

### BRIEF DESCRIPTION OF THE DRAWINGS

For a fuller understanding of the nature and objects of the present invention, reference should be made to the following detailed description taken in connection with the accompanying drawings, wherein:

FIG. 1 is an illustration of a prior art capacitive pressure transducer.

FIG. 2 is a graph of the relationship between a sensed pressure and an output voltage in a pressure transducer.

FIG. 3 is an illustration of a capacitive pressure transducer incorporating an output shaping circuit in accordance with the present invention.

FIG. 4A is a graph of the relationship between a sensed pressure and an output voltage in accordance with an embodiment of the present invention.

FIG. 4B is an graph of the relationship between the input voltage and output voltage of an output shaping circuit in accordance with an embodiment of the present invention.

FIG. 5 is a circuit diagram of an output shaping circuit in accordance with an embodiment of the present invention.

FIG. 6 is a circuit diagram of the output shaping circuit of FIG. 5.

FIG. 7 is a graph illustrating the relationship between various currents and the input voltage in the output shaping circuit of FIG. 5 in accordance with an embodiment of the present invention.

FIG. 8 is a graph illustrating the relationship between intermediate voltage values at nodes and the input voltage in the output shaping circuit in accordance with an embodiment of the invention.

FIG. 9 is a circuit diagram of an output shaping circuit in accordance with an embodiment of the present invention.

FIG. 10A is a graph of the relationship between a sensed pressure and an output voltage of an output shaping circuit in accordance with an embodiment of the present invention.

FIG. 10B is an graph of the relationship between the input voltage and output voltage of an output shaping circuit in accordance with an embodiment of the present invention.

### DETAILED DESCRIPTION OF THE DRAWINGS

The present invention is directed to a pressure transducer having an output signal characterized by two or more slopes. Embodiments of the present invention include an electrical circuit for shaping an intermediate output signal from a pressure transducer to produce a shaped pressure transducer output signal.

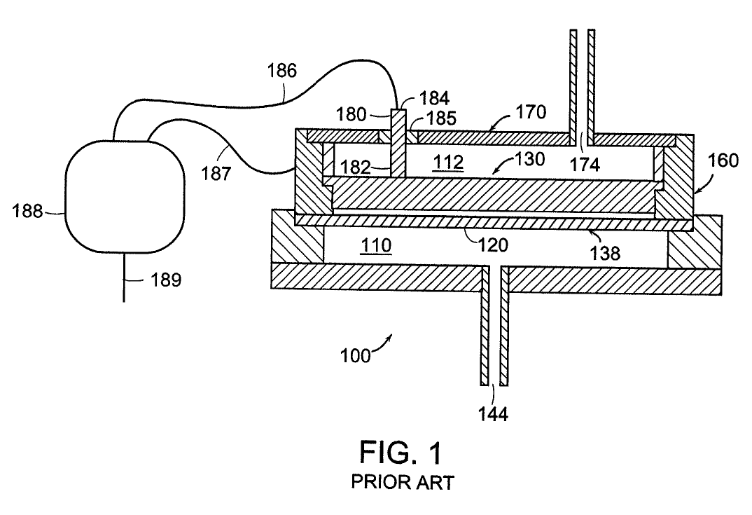

By way of example, embodiments of the present invention may be used in conjunction with pressure transducers of the capacitive type. Although the capacitor-based pressure transducer illustrated in FIG. 1 is one transducer that may be used with the present invention, a transducer of any desired type or design may be used.

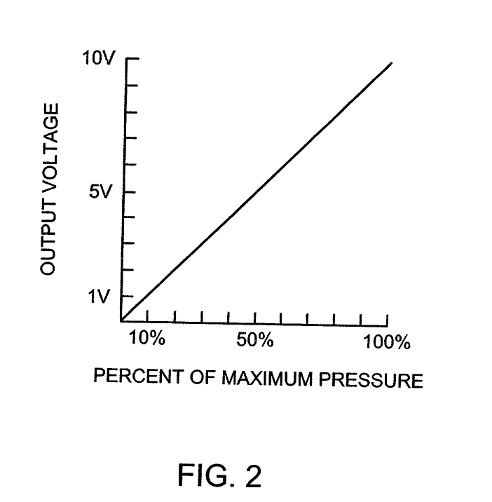

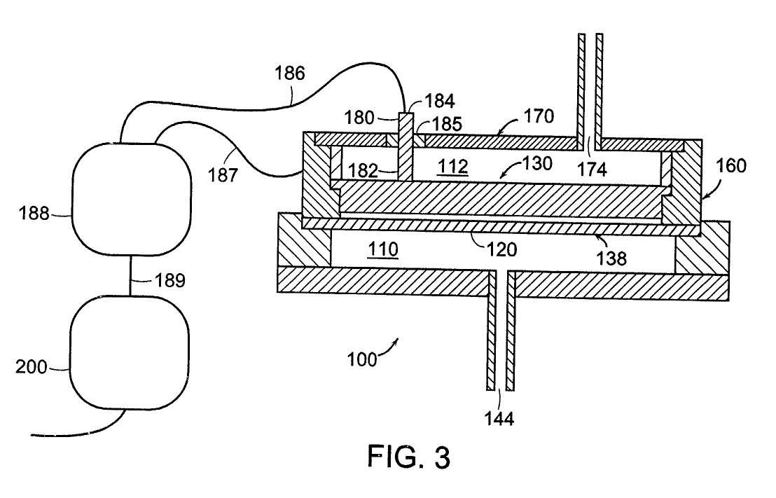

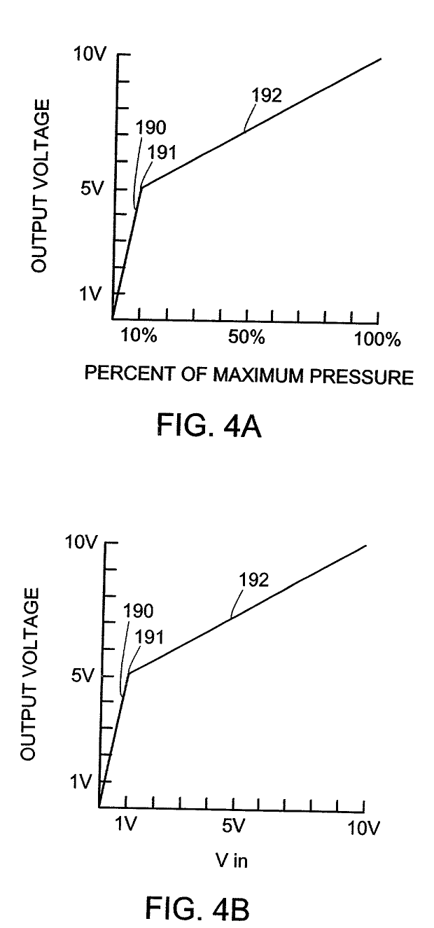

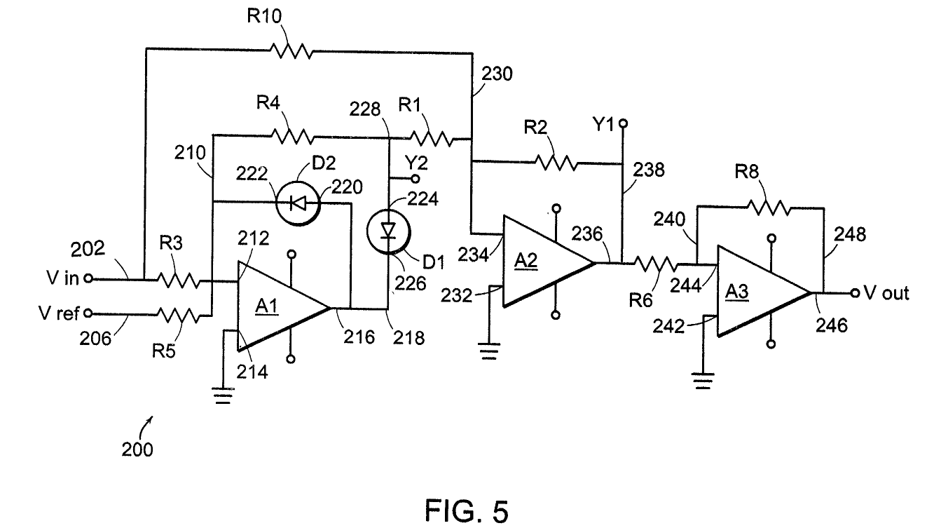

In some embodiments of the present invention, electrical circuitry shapes an intermediate output signal from a pressure transducer, such as the signal shown in FIG. 2, to provide a shaped output signal that is representative of the sensed pressure for at least two desired ranges of pressures and that is characterized by a dual slope. A capacitive pressure transducer incorporating a shaping circuit 200 in accordance with embodiments of the invention is shown in FIG. 3. FIG. 4A shows a graph of the relationship between a sensed pressure and an output voltage from an output shaping circuit in accordance with an embodiment of the invention. FIG. 4B is a graph of the relationship between the input voltage and the output voltage of an output shaping circuit in accordance with an embodiment of the invention. FIG. 5 is a circuit diagram of one output shaping circuit 200 that may be used to implement the present invention. In accordance with the present invention, an intermediate output signal from the front end electronics of the pressure transducer is provided as an input Vin at node 202 to the output shaping circuit 200. The output shaping circuit 200 provides an output Vout at node 248 having the characteristic shown in FIG. 4B as a function of the intermediate output signal in.

As explained above, a pressure transducer senses pressure over a total pressure sensing range within which one or more subranges may be of particular interest. Analog-to-digital converters in a user's system may nothave enough resolution to accurately measure the low end of the output range. In operation, the output shaping circuit 200 advantageously boosts the slope of the intermediate output signal corresponding to a relatively low desired pressure subrange. Because the slope of the shaped output signal is increased, small changes in the sensed pressure will result in a larger difference in the shaped output signal as compared with the intermediate output signal. Thus, an analog-to-digital converter will more easily resolve the shaped output signal for a low desired pressure subrange. Additionally, it is preferred that the overall output of the shaping circuit 200 be within a certain range, typically the same total voltage range as the intermediate output signal. In accordance with embodiments of the present invention, the output shaping circuit 200 also attenuates the slope of the intermediate output signal in a relatively high voltage output range corresponding to a second, relatively high desired pressure subrange. Accordingly, the overall total output voltage range of shaping circuit 200 is the same as or substantially similar to the intermediate output voltage range, e.g., 10 volts.

The output signal produced by the output shaping circuit 200 has the dual slope characteristic shown in FIGS. 4A and 4B. The first slope 190 corresponds to a first sensed pressure subrange, and the second slope 192 corresponds to a second sensed pressure subrange; the two slopes intersect at a “knee” point 191. For the shaping circuit 200, the first slope 190 corresponds to a pressure subrange up to 10 percent of the total sensed pressure range, and the second slope 192 corresponds to a pressure subrange from 10 percent to 100 percent of the total sensed pressure range. In the illustrated embodiment, relative to the intermediate output signal, the slope of the shaped output signal is boosted by a factor of 5 in the low subrange and attenuated by a factor of 5/9 in the higher subrange. At 5 percent of the total sensed pressure range, the intermediate output is 0.5 volts and the shaped output is 2.5 volts. At 10 percent of the total sensed pressure range, the intermediate output is 1 volt and the shaped output is 5 volts. At 50 percent of the total sensed pressure range, the intermediate output is 5 volts, and the shaped output is 7.22 volts. At 100 percent of the total pressure range, both the intermediate output and the shaped output are 10 volts. So, for the example in which the input pressure range of the most interest is 5-8 milliTorr, whereas the intermediate output corresponding to this range is 0.25 V to 0.4 V, the shaped output corresponding to this range is increased to 1.25 volts to 2.00 volts. Accordingly, analog-to-digital converters receiving the shaped output signal can more accurately resolve the pressure range of interest. (Electrical values specified herein are approximate.)

This illustration of a knee at 10% of the total sensed pressure range, with the slopes provided, is but one example of an embodiment in accordance with the present invention. The structure of shaping circuit 200 may now be discussed in greater detail. Referring again to FIG. 5, shaping circuit 200 includes three differential amplifiers, A1, A2, and A3; two diodes, D1, and D2; and eight resistors, R1, R2, R3, R4, R5, R6, R8, and R10. Shaping circuit 200 receives as an input Vin, the intermediate output signal from a pressure transducer, at a node 202. One terminal of resistor R3 is electrically connected to node 202 and the other terminal of resistor R3 is electrically connected to a node 210. Shaping circuit 200 also receives as an input Vref, a reference voltage for defining the knee point, at a node 206. One terminal of resistor R5 is electrically connected to node 206 and the other terminal of resistor R5 is electrically connected to node 210. Amplifier A1 has an inverting input 212, a non-inverting input 214 and an output 216. The inverting input 212 of amplifier A1 is electrically connected to node 210. The non-inverting input 214 of amplifier A1 is grounded. The output 216 of amplifier A1 is electrically connected to a node 218. The circuit 200 includes two feedback paths between the output 216 and the inverting input 212 of the amplifier A1. Diode D2 is connected between nodes 218 and 210 to form one feedback path. The anode 220 of diode D2 is connected to node 218 and the cathode 222 of diode D2 is connected to node 210. Diode D1 and resistor R4 are connected between nodes 218 and 210 form a second feedback path. The cathode 226 of diode D1 is connected to node 218 and the anode 224 of diode D1 is connected to a node 228. One terminal of resistor R4 is electrically connected to node 228 and the other terminal of resistor R4 is electrically connected to node 210. An output voltage Y2 for the first amplifier stage is shown at node 228 for convenient reference.

Vin is additionally connected from node 202 to a node 230 through resistor R10. That is, one terminal of resistor R10 is electrically connected to node 202 and the other terminal of resistor R10 is electrically connected to node 230. One terminal of resistor R1 is electrically connected to node 228 and the other terminal of resistor R1 is electrically connected to node 230. Amplifier A2 has an inverting input 234, a non-inverting input 232, and an output 236 and is connected in a summing configuration. The inverting input 234 is electrically connected to node 230, while the non-inverting input 232 is grounded. The output 236 is electrically connected to a node 238. A feedback path is provided from the output 236 to the inverting input 234 by resistor R2, electrically connected between nodes 238 and 230. An output voltage Y1 for the second amplifier stage is shown at node 238 for convenient reference.

One terminal of resistor R6 electrically connected to node 238 and the other terminal of resistor R6 is electrically connected to a node 240. Amplifier A3 has an inverting input 244, and a non-inverting input 242, and an output 246 and is connected in an inverting configuration. The inverting input 244 is connected to node 240, while the non-inverting input 242 is grounded. The output 246 is connected to a node 248. A feedback path is provided from the output 246 to the inverting input 244 through resistor R8. One terminal of resistor R8 is electrically connected to node 248 and the other terminal of resistor R8 is electrically connected to node 240. The output signal Vout is supplied at node 248.

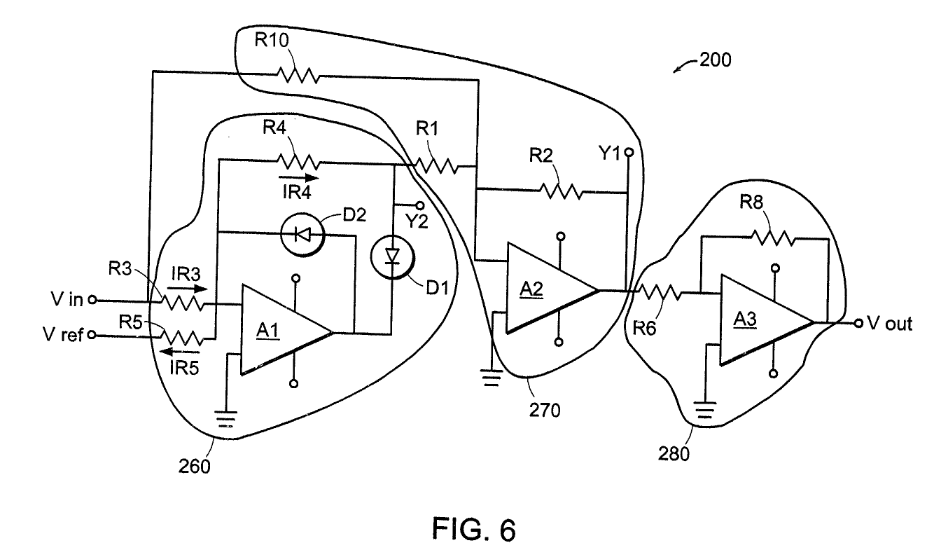

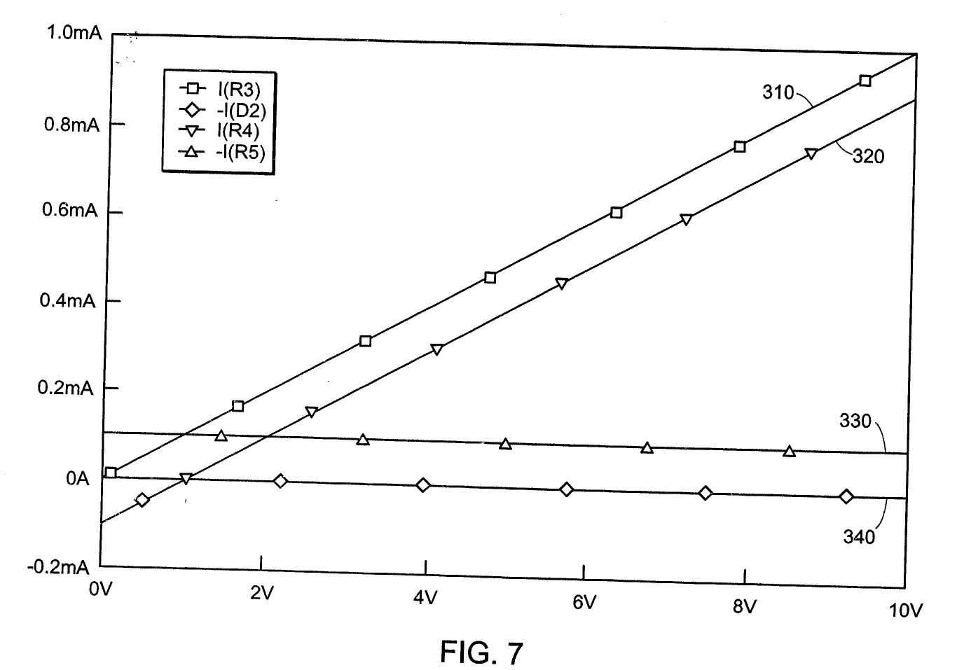

Referring additionally to FIG. 6, the operation of circuit 200 may now be described in greater detail. For ease of analysis, circuit 200 may be considered to comprise three stages 260, 270, and 280, associated with the three amplifiers A1, A2 and A3, respectively. The output of the first stage 260 is Y2; the output of the second stage 270 is Y1; and the output of the third stage 280 is Vout. Moreover, operation of the circuit may be considered when Vin is less than the knee point input voltage and greater than the knee point input voltage.

The circuit stage 260 defined by amplifier A1 produces an output Y2 that establishes the knee input voltage and attenuates the slope of the input voltage above the knee input voltage. The signal Y2 will be used to shape Vin to provide the shaped output signal. The knee input voltage is defined such that when Vin is less than the knee input voltage, the magnitude of IR3 will be less than the magnitude of IR5. IR3 is the current through R3 as shown in FIG. 6. IR5 is the current through R5 as further shown in FIG. 5. Vref is an offset voltage that is used to define the knee input voltage. Since its non-inverting input is grounded, operational amplifier A1 maintains its inverting input at a virtual ground. Accordingly, IR3 and IR5 may be calculated as follows:

$$IR3 = \frac{Vin}{R3} , and IR5 = \frac{- Vref}{R5} .$$

Vin will typically be between 0 and 10 volts and is assumed to be a positive voltage. Vref may be a negative voltage. Accordingly, below the knee input voltage:

$$\frac{Vin}{R3} < \vert \frac{Vref}{R5} \vert ,$$

from which it follows that

$$Vin < \vert Vref * \frac{R3}{R5} \vert .$$

In this condition, diode D2 will be on and will conduct current ID2 to maintain node 210, connected to the inverting input 212 of the amplifier A1, at zero potential. D1 will be off and no current will flow through R4. Consequently, output Y2 will be at the same potential as the inverting input of amplifier A1, i.e., virtual ground. In summary, Y2, the output of the stage 260 defined by amplifier A1, will be at virtual ground when

$$Vin < \vert Vref * \frac{R3}{R5} \vert ,$$

(i.e., when Vin is

below the knee point).

In the alternate condition, when Vin is above the knee point, or voltage, IR3 will be greater than IR5. Accordingly,

$$Vin > \vert Vref * \frac{R3}{R5} \vert$$

(i.e., because the magnitude of IR3 will be greater than the magnitude of IR5). In this condition, current IR4 equal to (IR3−IR5) will flow through R4. Again with the virtual ground at node 210 as a reference, the voltage Y2 will be described as:

Y2=−IR4*R4, or Y2=−(IR3−IR5)*R4, or

$$Y2 = - ( \frac{Vin}{R3} - \frac{- Vref}{R5} ) * R4 , or Y2 = - ( \frac{Vin}{R3} + \frac{Vref}{R5} ) * R4 , or$$

$$Y2 = - Vref * \frac{R4}{R5} - Vin * \frac{R4}{R3} .$$

Referring to FIG. 6, the graph shows the magnitudes of various currents IR3, IR4, IR5 and ID2 relative to Vin. IR3 has the output characteristic 310; IR4 has the output characteristic 320; IR5 has the output characteristic 330; ID2 has the output characteristic 340.

In summary, for the first stage of the circuit,

$$Y2 = \{ \begin{matrix}- Vref * \frac{R4}{R5} - Vin * \frac{R4}{R3} for Vin > \vert Vref * \frac{R3}{R5} \vert \\ 0 otherwise\end{matrix} \qquad ( 1 )$$

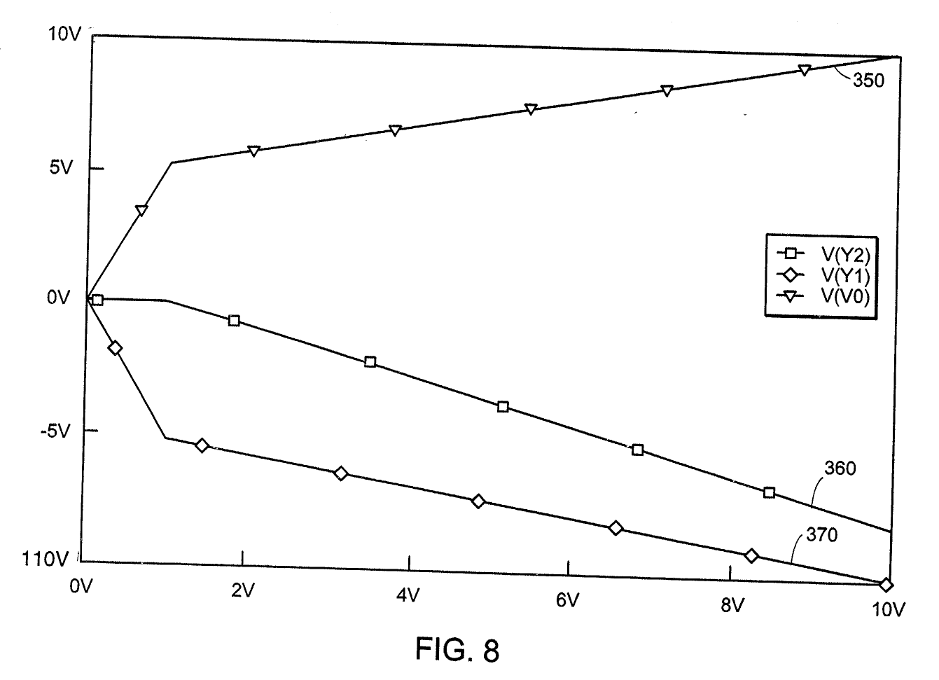

Y2 has the output characteristic 360 shown in FIG. 8. The resistor values R3 and R5, as well as Vref, may be selected to set the desired knee point with respect to the input Vin of the circuit 200.

Referring again to FIG. 6, the next stage 270 of the circuit 200 is associated with amplifier A2, which is configured as a summing amplifier. In the second stage 270, Y2 is used to shape Vin. The output Y1 of the second stage 270 is equal to the shaped output signal Vout, but is inverted. In the second stage 270 of the circuit 200, amplifier A2 sums Vin with the shaping function defined by signal Y2 to obtain Y1, which has the desired output signal shape; gain resistors further provide amplification so that Y1 also has the desired output signal slopes. Amplifier A2 sums the two signals that are connected to its inverting input 234 at node 230, with gain factors depending on the associated resistors. These signals are Vin, with gain resistors R2 and R10, and Y2, with gain resistors R2 and R1. The output of the second stage 270 of circuit 200, Y1, is given by:

$$Y1 = - Y2 * \frac{R2}{R1} - Vin * \frac{R2}{R10} .$$

Substituting Y2 from Equation (1) above, Y1 becomes

$$Y1 = - \frac{R2}{R1} * ( - Vref * \frac{R4}{R5} - Vin * \frac{R4}{R3} ) - Vin * \frac{R2}{R10} ,$$

which becomes

$$Y1 = Vref * \frac{R2 * R4}{R1 * R5} + Vin * \frac{R2 * R4}{R1 * R3} - Vin * \frac{R2}{R10} ,$$

and simplifies to

$$Y1 = Vref ⋆ \frac{R2 ⋆ R4}{R1 ⋆ R5} - Vin ⋆ ( \frac{R2}{R10} - \frac{R2 ⋆ R4}{R1 ⋆ R3} ) \cdot \qquad ( 2 )$$

Y1 has the output characteristic 370 shown in FIG. 8. Circuit elements may be selected with equal values for R1 and R10 so that the overall gain of the second stage 270 with respect to both the Y2 and Vin inputs will be the same.

The third stage 280 of the circuit 200 is associated with amplifier A3, which is configured as an inverting amplifier. Because Y1 is equal to the desired shaped output signal Vout, but is inverted, amplifier A3 merely inverts Y1, preferably with a gain of 1, to produce Vout, the output of the third stage 280, as well as of the overall circuit 200. Vout as the output of amplifier A3 is defined as:

$$Vout = - Y1 ⋆ \frac{R8}{R6} . \qquad ( 3 )$$

Preferably, R8 is equal to R6 so that the gain of the third stage 280 is unity and the overall effect is merely to invert Y1. Vout has the output characteristic 350 shown in FIG. 8.

In review, below the knee point, Y2 will be zero and Y1 will have an amplified slope relative to the input Vin. Above the knee, Y2 will have a negative slope and, when Y2 is summed with Vin, Y1 will have an attenuated slope relative to the input Vin. Vout is Y1 inverted. Combining equations (1), (2) and (3) for the stages 260, 270, and 280 provides the following equation for the dual slope output Vout of circuit 200:

$$Vout = \vert \begin{matrix}- Vref ⋆ \frac{R2 ⋆ R4 ⋆ R8}{R1 ⋆ R5 ⋆ R6} + Vin ⋆ ( \frac{R2}{R10} - \frac{R2 ⋆ R4}{R1 ⋆ R3} ) ⋆ \frac{R8}{R6} & if Vin > \vert Vref \vert ⋆ \frac{R3}{R5} \\ Vin ⋆ \frac{R2 ⋆ R8}{R6 ⋆ R10} & otherwise .\end{matrix} \qquad ( 4 )$$

The values of circuit elements may be selected in accordance with desired characteristics for Vout. For example, the values of the resistors may be obtained, at least in part, by: (1) simplifying the selection by selecting R1 and R10 to be equal to each other so the R2 is determinative and selecting R2 so that Y1 includes the desired gain for Vout below the knee point, e.g., a gain of 5; (2) selecting R5 such that the knee point is just past the upper endpoint of the desired low subrange, e.g., at 1.0005 volts; and (3) adjusting R4 so that Y1 is 10 volts when Vin is 10 volts. The preferred values for circuit elements in accordance with one embodiment of the present invention are shown in the following table:

| Vref | −5 volts | |
|---|---|---|
| R1 | 10200 | ohms |
| R2 | 51000 | ohms |
| R3 | 10200 | ohms |
| R4 | 9067.1 | ohms |
| R5 | 50975 | ohms |
| R6 | 10000 | ohms |
| R8 | 10000 | ohms |
| R10 | 10200 | ohms |

For circuit 200 implemented with elements of these values, the knee point will be at approximately 1 volt, the first slope below the knee point will be approximately 5 and the second slope above the knee point will be approximately 5/9.

In accordance with the invention, the shaped output Vout of circuit 200 has a dual slope characteristic, with a higher slope at a lower output voltage range and lower slope at a higher voltage output range. Each slope corresponds to a desired operating pressure subrange. The knee point occurs at a point between two desired pressure subranges. The output Vout may be connected, for example, to an analog-to-digital converter.

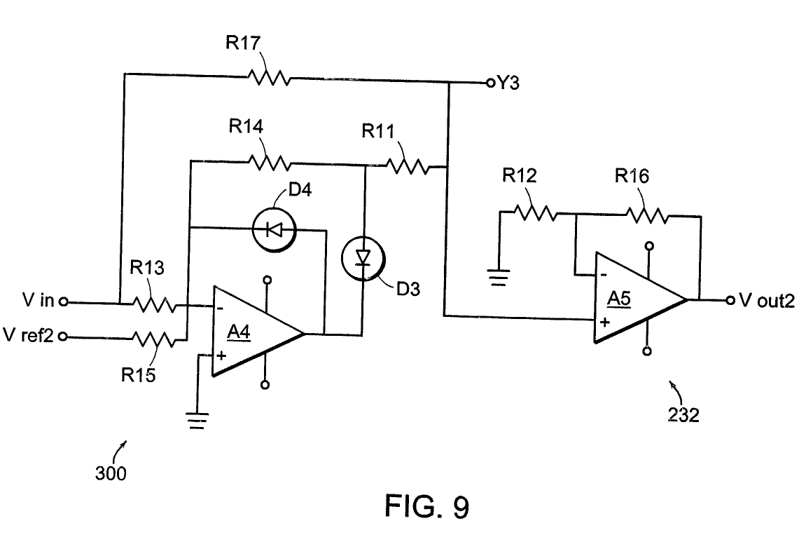

An alternative embodiment 300 of an output shaping circuit is illustrated in FIG. 9. Output shaping circuit 300 incorporates two amplifiers A4 and A5. The circuitry associated with amplifier A4 is similar to the circuitry associated with amplifier A1 in output shaping circuit 200. In contrast to output shaping circuit 200, in output shaping circuit 300, the output of the first amplifier stage is connected to the non-inverting input of the amplifier A5. After study, it will be appreciated that Vknee for circuit 300 is given by the following equation:

$$Vknee = \frac{- Vref}{R15} ⋆ \frac{R13 ⋆ ( R17 + R11 + R14 )}{R13 + R17 + R11 + R14} .$$

In addition, Y3 for circuit 300 is given by the following equation:

$$Y3 = \vert \begin{matrix}Vin - R17 ⋆ \frac{Vin + ( \frac{Vin}{R13} + \frac{Vref2}{R15} ) ⋆ R14}{R11 + R17} & if ( Vin > \vert Vknee \vert ) \\ Vin * ( 1 - \frac{R17}{R17 + R11 + R14} ) & otherwise .\end{matrix}$$

And further, Vout2 is given by:

$$Vout2 = Y3 ⋆ ( 1 + \frac{R16}{R12} ) \cdot$$

The resistor values throughout circuit 300 are selected to provide the desired output given the transfer characteristics of output shaping circuit 300. Due to interactions between the stages of the circuit 300, an iterative process may be useful for selecting the resistor values. For example, circuit 300 can be made to have substantially the same transfer function as circuit 200 by selecting resistor values, at least in part, by: (1) adjusting R15 to set initially the knee input voltage; (2) selecting R14 to obtain the desired ratio between the maximum Vout value and the Vout value for Vknee, which for circuit 200 is 2 (10 volts/5 volts); (3) repeating steps 1 and 2 with incremental adjustments to R15 and R14 until the desired values are obtained for Vknee and the Vout ratio; and (4) adjusting R16 such that Vout is 10 volts when Vin is 10 volts. The remaining resistor values can be selected accordingly. The preferred values for circuit elements in accordance with one embodiment of the present invention are shown in the following table:

| Vref | −5 volts | |
|---|---|---|
| R11 | 10000 | ohms |
| R12 | 1000 | ohms |
| R13 | 10000 | ohms |
| R14 | 8556 | ohms |
| R15 | 37030 | ohms |
| R16 | 6695 | ohms |
| R17 | 10000 | ohms |

For circuit 300 implemented with elements of these values, the knee point will be at approximately 1 volt, the first slope below the knee point will be approximately 5 and the second slope above the knee point will be approximately 5/9.

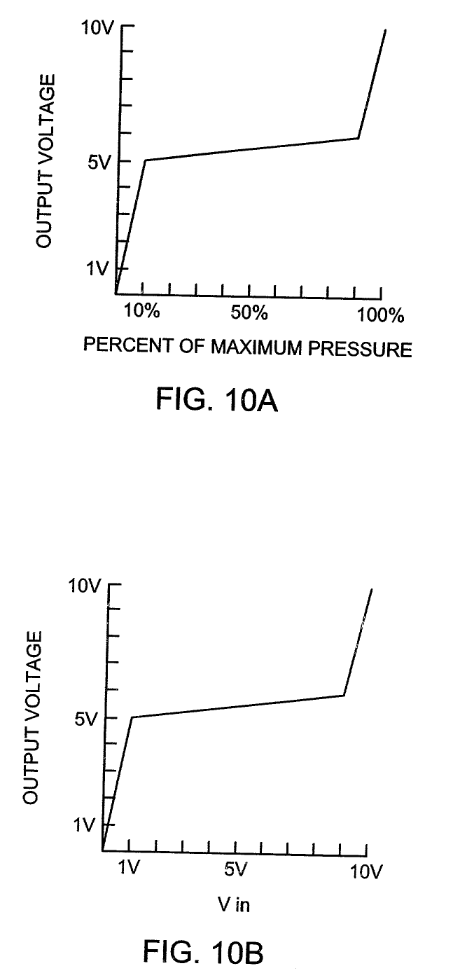

Although the invention has been illustrated and described herein with reference to particular circuits 200 and 300, various other circuits similar to or substantially different from circuits 200 and 300 could be used in accordance with the present invention. Circuits 200 and 300 has been shown and described by way of illustration and explanation and not by way of limitation. A circuit producing a shaped output signal characterized by more than two slopes may be provided in accordance with the invention. For example, in some embodiments it may be desirable to (1) associate a relatively steep slope with a low sub-range of interest, (2) associate a relatively steep slope with a high sub-range of interest, and (3) provide a relatively flat slope in the region between the low and high sub-ranges of interest. Such a system boosts the accuracy in two sub-ranges of interest and decreases the accuracy in the region between the two sub-ranges of interest. FIGS. 10A and 10B shows an example of such a shaped output voltage. This may be accomplished by using additional amplifier sections. Clearly, the invention further embraces boosting the slope in even more than two sub-ranges of interest. The invention also embraces boosting the slope with logarithmic elements, such as diodes, and producing a logarithmic output.

The present invention may be incorporated into a transducer or may be supplied separately as an interface to a transducer. While the present invention has been illustrated and described with reference to preferred embodiments thereof, it will be apparent to those skilled in the art that modifications can be made and the invention can be practiced in other environments without departing from the spirit and scope of the invention, set forth in the accompanying claims.

What is claimed is:

1. A pressure transducer assembly, comprising:
a pressure transducer, the transducer generating a first output signal representative of a sensed pressure;
a shaping circuit, the circuit generating a second output signal in response to the first output signal, the second output signal being generated according to a first function of the first output signal when the first output signal is less than a first value, the second output signal being generated according to a second function of the first output signal when the first output signal is greater than a second value, the first function being different than the second function.

2. The pressure transducer assembly of claim 1, wherein the first function is a linear function and the second function is a linear function.

3. The pressure transducer assembly of claim 2, wherein the first function is characterized by a first slope and the second function is characterized by a second slope, wherein the first slope is greater than the second slope.

4. The pressure transducer assembly of claim 1, wherein the first slope is greater than 1.

5. The pressure transducer assembly of claim 1, wherein the first value is less than the second value.

6. The pressure transducer assembly of claim 1, wherein the first value equals the second value.

7. The pressure transducer assembly of claim 1, wherein the first value corresponds to the first output signal being at approximately 10 percent of a total sensed pressure range of the pressure transducer.

8. The pressure transducer assembly of claim 1, further comprising an analog-to-digital converter, the second output signal being connected to an input of the analog-to-digital converter.

9. The pressure transducer assembly of claim 1, wherein the range of the first output signal is the same as the range of the second output signal.

10. A method of generating an output signal for a pressure transducer, the method comprising generating the output signal according to a first function of a sensed pressure when the sensed pressure is less than a first value and generating the output signal according to a second function of the sensed pressure when the sensed pressure is greater than a second value, the second function being different than the first function.

11. The method of claim 10, wherein the first function is a linear function and the second function is a linear function.

12. The pressure transducer assembly of claim 2, wherein the first function is characterized by a first slope and the second function is characterized by a second slope, wherein the first slope is greater than the second slope.

13. The pressure transducer assembly of claim 1, wherein the first slope is greater than 1.

14. The pressure transducer assembly of claim 1, wherein the first value is less than the second value.

15. The pressure transducer assembly of claim 1, wherein the first value equals the second value.

16. A pressure transducer assembly, comprising:
a capacitive pressure transducer producing a first output signal, the first output signal being substantially linear; and
a shaping electrical circuit producing a shaped output signal that is a function of the first output signal, the function being characterized by at least two slopes, the electrical circuit comprising a first amplifier stage for generating a shaping function.

17. The pressure transducer assembly of claim 16, wherein the shaping function includes a first slope and a second slope that is different from the first slope.

18. The pressure transducer assembly of claim 16, further comprising a second amplifier stage for applying the shaping function to the intermediate output signal.

19. The pressure transducer assembly of claim 18, wherein the second amplifier stage has a summing amplifier configuration and sums the intermediate output signal with the shaping function.

20. The pressure transducer assembly of claim 16, wherein the first amplifier stage includes a feedback path from an output of a first amplifier to an inverting input of the first amplifier and a shunt path from an output of a first amplifier to the inverting input, the feedback path being triggered above a knee point, and the shunt path being triggered below the knee point.
